(19) United States
(12) Patent Application Publication
(10) Pub. No.: US 2006/0026668 A1
(43) Pub. Date: Feb. 2, 2006

(54) Web application framework

(75) Inventor: Stephane Karoubi, Mt. View, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/909,039

(22) Filed: Jul. 30, 2004

(51) Int. Cl. H04L 9/32; G06K 9/00; G06F 17/30; G06F 15/16; G06F 7/04; G06F 7/58; G06K 19/00

(52) U.S. Cl. 726/4

(57) ABSTRACT

A web application framework is described. A web application framework class that inherits from an ASP.NET framework class is defined and used to maintain global code that may be accessed by one or more web-based applications. A global class associated with each web-based application is modified to inherit from the web application framework class rather than from the ASP.NET framework class. Code in the ASP.NET framework class can be overridden or customized by code in either the web application framework class or an application-specific global class. Code in the web application framework class can be overridden or customized by code in the application-specific global class.

### TECHNICAL FIELD

This invention relates to web applications, and more specifically to a framework that provides centralized code that can be accessed by multiple web applications.

### BACKGROUND

ASP.NET provides a framework through which web-based applications may be developed. The ASP.NET framework includes a System.Web.HttpApplication class that provides a wide variety of functionality that can be accessed by ASP.NET applications. Each ASP.NET application includes a Global.asax file that may be used to define global code associated with the application, and/or to override or customize functions that are available through the System.Web.HttpApplication class.

While a Global.asax file supports application-specific code, the code associated with the System.Web.HttpApplication is part of the ASP.NET framework, and can not be modified by a developer. Therefore, if a developer wants to customize a particular function to be used in multiple applications, code duplication becomes a necessity. That is, the customized code can be added to each application's Global.asax file. This type of code duplication becomes difficult to maintain, for example, for a company that provides several web-based applications, all with a consistent look and feel. Accordingly, a need exists for a framework that enables developers to create centralized code that can be accessed by multiple ASP.NET web applications.

### SUMMARY

Techniques for enabling and maintaining code that may be accessed by multiple web-based applications are described. Rather than being duplicated and associated with multiple web-based application-specific classes, global code is maintained as part of a class associated with a web application framework. The web-based application-specific classes are then modified to inherit from the web application framework class.

### BRIEF DESCRIPTION OF THE DRAWINGS

FIG. 1 is a block diagram that illustrates an exemplary environment in which a web application framework may be implemented.

FIG. 2 is a block diagram that illustrates the relationship between a web application framework and two ASP.NET web-based applications.

FIG. 3a is a block diagram that illustrates source code examples for two web-based applications before implementation of a web application framework.

FIG. 3b is a block diagram that illustrates source code examples for the two web-based applications shown in FIG. 3 after implementation of a web application framework.

FIG. 4 is a flow diagram that illustrates an exemplary method for utilizing a web application framework.

### DETAILED DESCRIPTION

Overview

The embodiments described below provide a framework for enabling and maintaining centralized code that can be accessed by multiple web-based applications. In the described implementation, code that is to be shared across multiple web-based applications is stored in a web application framework. According to the current ASP.NET framework, the global class found in an application's Global.asax file is a descendent of the System.Web.HttpApplication class, which is part of the ASP.NET runtime environment. As such, by default, the global subclass inherits state and methods from the System.Web.HttpApplication class. In the described implementation, the global class is modified to inherit from a Microsoft.MsnTv.Web.WebGlobal class that is configured to inherit from the System.Web.HttpApplication class. As such, System.Web.HttpApplication methods can be overridden in the Microsoft.MsnTv.Web.WebGlobal class, which is then accessible by any web application that has a global class defined to inherit from the Microsoft.MsnTv.Web.WebGlobal class.

In a typical web-based application, code can be added to the global class to override or customize code that is in the System.Web.HttpApplication class. Similarly, when using the web application framework, code in the web application framework can override or customize code that is in the System.Web.HttpApplication class and code in the global class can override or customize code that is in the Microsoft.MsnTv.Web.WebGlobal class or code that is in the System.Web.HttpApplication class.

Network Environment

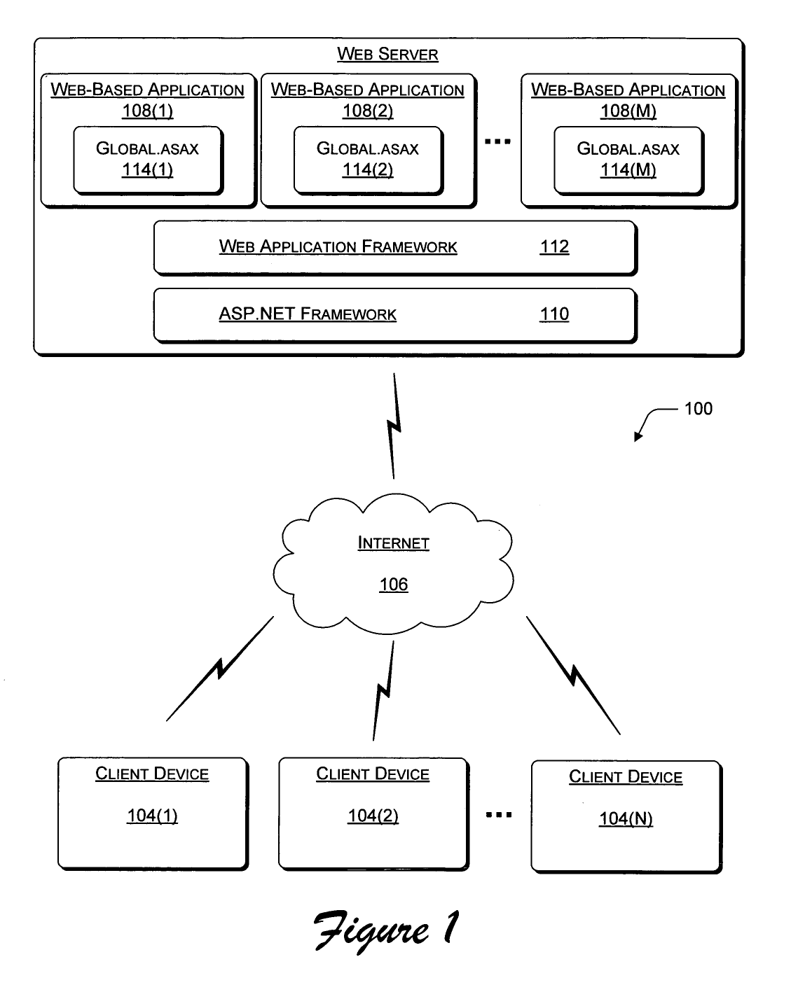

FIG. 1 illustrates an exemplary network environment 100 in which a web application framework may be implemented. The illustrated environment includes a web server 102 and client devices 104(1), 104(2), . . . , 104(N), each configured to communicate with web server 102 over a network such as the Internet 106.

Client devices 104 may be implemented as any type of client device capable of accessing web-based applications over the Internet (or other type of network). Example client devices may include, but are not limited to, a personal computer, a handheld computing device, a personal digital assistant (PDA), a television set-top box, and so on.

Web server 102 includes one or more web-based applications 108(1), 108(2), . . . , 108(M), an ASP.NET framework 110, and a web application framework 112. In the illustrated example, web-based applications 108 are implemented using ASP.NET. As such, each web-based application 108 includes a Global.asax file 114(1), 114(2), . . . 114(M), which is an ASP.NET application requirement. By default, based on the ASP.NET framework, an application's Global.asax file includes a global class that inherits from an System.Web.HttpApplication class that is part of the ASP.NET framework 110.

Web application framework 112 may be implemented, for example, to include a webglobal class. The webglobal class is defined to inherit from the System.Web.HttpApplication class. Similar to a Global.asax file that inherits from the System.Web.HttpApplication class, the webglobal class can be used to override or customize code that is available through the System.Web.HttpApplication class. Furthermore, like an application-specific global class, the webglobal class can include additional code that is not available through the System.Web.HttpApplication class. The webglobal class may also include code that calls other code stored, for example, as a dynamic link library (DLL).

One or more of the web-based applications 114 can be modified to take advantage of code that is maintained in web application framework 112. For example, the global class in Global.asax file 114 can be modified to inherit from the webglobal class of web application framework 112 instead of from the System.Web.HttpApplication class of the ASP.NET framework. Because the webglobal class is defined to inherit from the System.Web.HttpApplication class, web-based application 108(1) will still have access to the code found in the System.Web.HttpApplication class of the ASP.NET framework, provided it has not been overridden by code in either the Global.asax file 114(1) or the global class of the web application framework 112.

Web server 102 may also include other components that are not illustrated in FIG. 1, such as a processor, one or more memory components, one or more network interfaces, and so on.

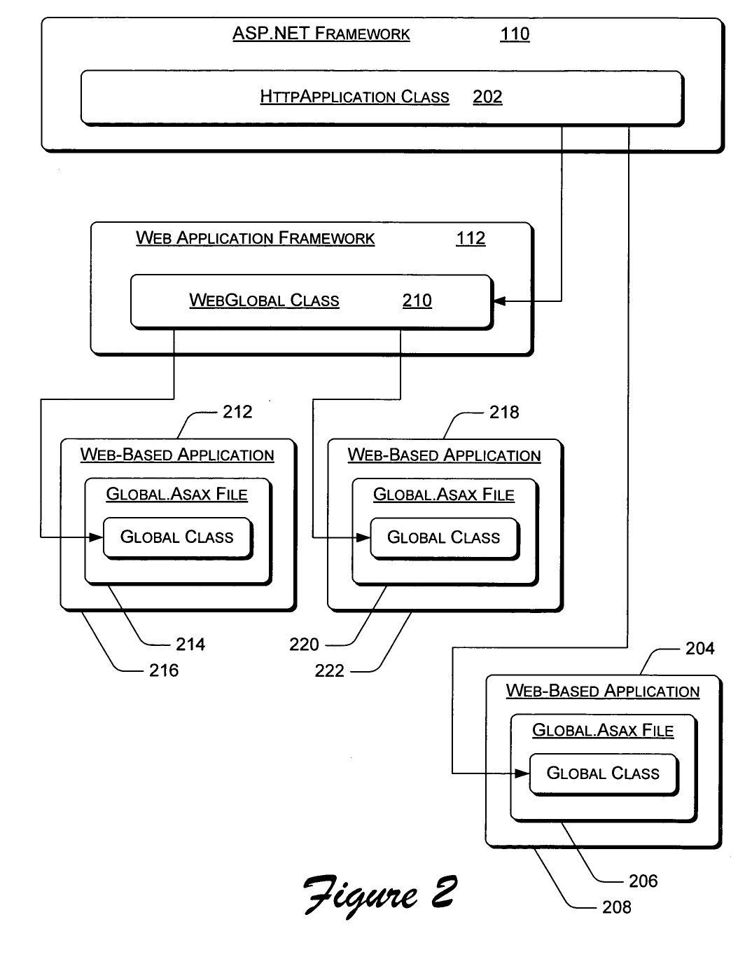

FIG. 2 illustrates the relationship between classes associated with the ASP.NET framework, the web application framework, and multiple web-based applications. As illustrated in FIG. 2, ASP.NET framework 110 includes an System.Web.HttpApplication class 202. A traditional web-based application 204 has Global.asax file 206, which includes a global class 208. Global class 208 inherits from System.Web.HttpApplication 202, which includes code that can be accessed from any web-based application.

Web application framework 112 includes webglobal class 210, which is defined to inherit from System.Web.HttpApplication class 202. Web-based application 212 also has a Global.asax file 214. Global.asax file 214 differs from Global.asax file 206 in that global class 216 is defined to inherit from webglobal class 210 rather than from System.Web.HttpApplication class 202. As such, custom code not available in the System.Web.HttpApplication class 202 can be maintained in the webglobal class 210 and accessed by web-based application 212. Similarly, web-based application 218 includes Global.asax file 220, which includes global class 222 defined to inherit from webglobal class 210. As such, web applications 212 and 218 can both take advantage of global code stored in the webglobal class 210.

Furthermore, another class similar to webglobal class 210 may be defined to support another group of applications. For example, webglobal class 210 may include code that applies to web-based applications 212 and 218 while a webgloball class (not shown) may be configured to also inherit from System.Web.HttpApplication class 202, but include code that applies to another group of web-based applications (not shown).

Exemplary Web Application Framework

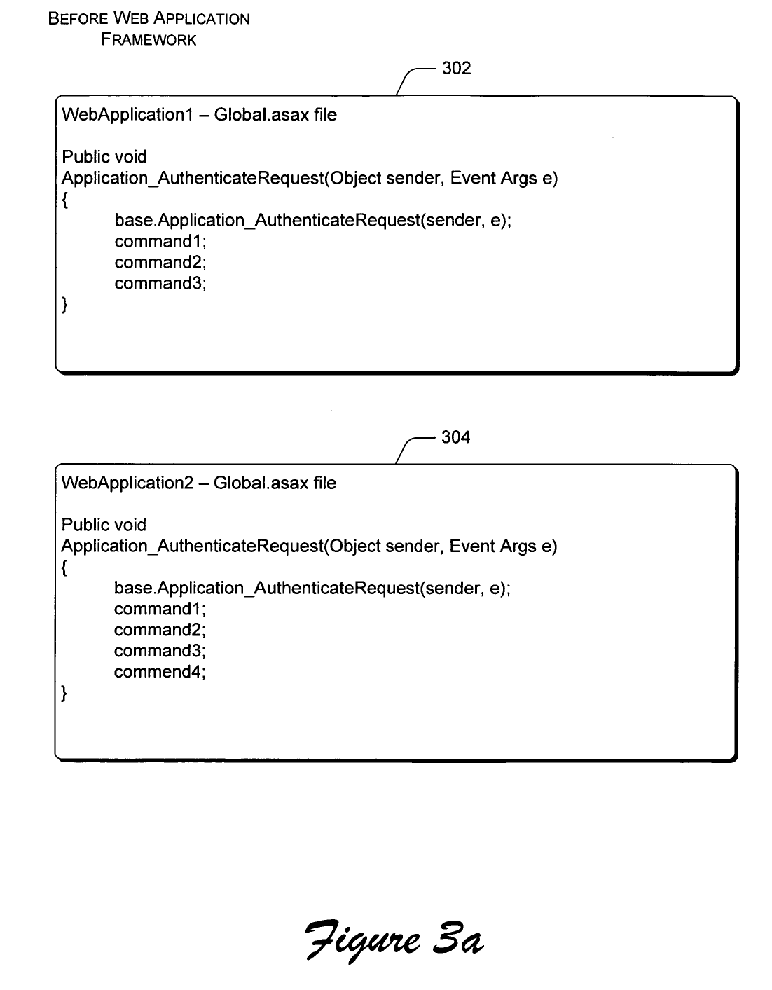

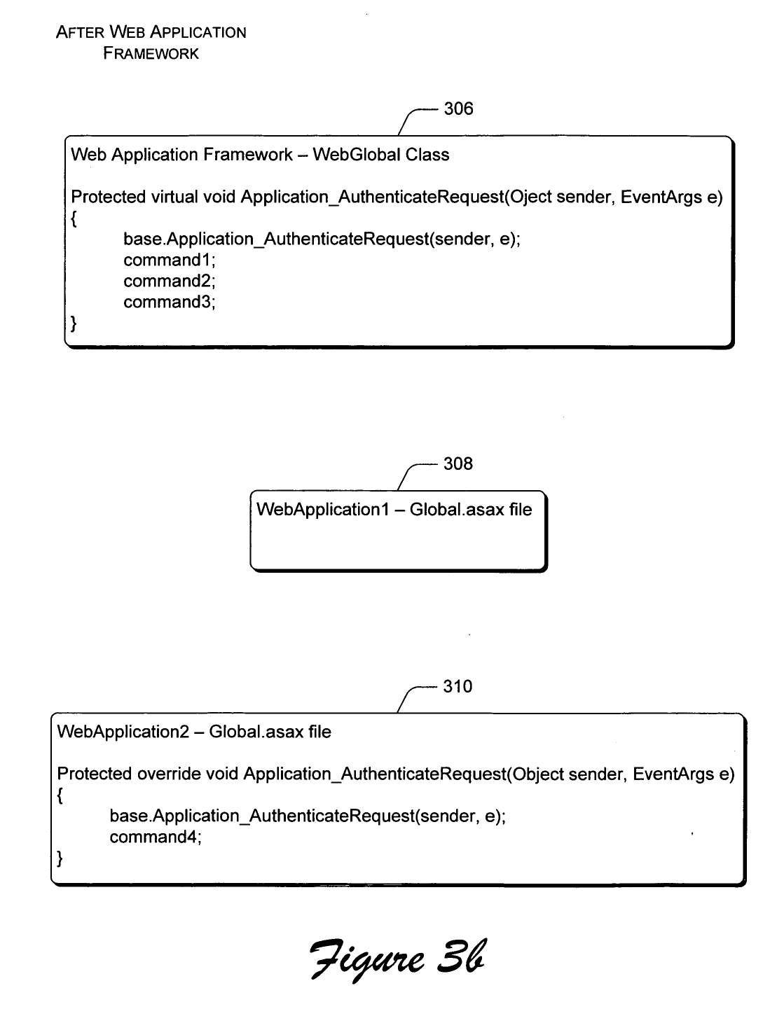

FIGS. 3a and 3b illustrate how the web application framework described herein can be used to reduce duplicate code across multiple web-based applications. Box 302 (shown in FIG. 3a) illustrates an example portion of code that may be included in a Global.asax file associated with a first web application (WebApplication1). The illustrated code sample indicates that the global class associated with WebApplication1 includes a customized AuthenticateRequest method. The customized AuthenticateRequest method includes three commands (command1, command2, and command3) in addition to the commands found in the System.Web.HttpApplication.authenticate method (not shown).

Similarly, box 304 illustrates an example portion of code that may be included in a Global.asax file associated with a second web application (WebApplication2). The illustrated code sample indicates that the global class associated with WebApplication2 also includes a customized AuthenticateRequest method. The customized AuthenticateRequest method includes four commands (command1, command2, command3, and command4) in addition to the commands found in the System.Web.HttpApplication.authenticate method (not shown).

Boxes 306, 308, and 310 (shown in FIG. 3b) illustrate example code that may be associated with the web application framework webglobal class, the WebApplication1 global class, and the WebApplication1 global class, respectively. Box 306 illustrates that the web application framework webglobal class includes a customized AuthenticateRequest method that includes the commands found in the System.Web.HttpApplication.authenticate method (not shown), command1, command2, and command3. Box 308 illustrates that the WebApplication1 global class no longer includes a customized AuthenticateRequest method because the WebApplication1 global class is defined to inherit from the webglobal class, which includes a customized AuthenticateRequest method. Box 310 illustrates that the WebApplication2 global class still includes a customized AuthenticateRequest method, but that the customization only consists of the addition of command4 because command1, command2, and command3 are all part of the customized AuthenticateRequest method associated with the webglobal class.

Utilizing the Web Application Framework

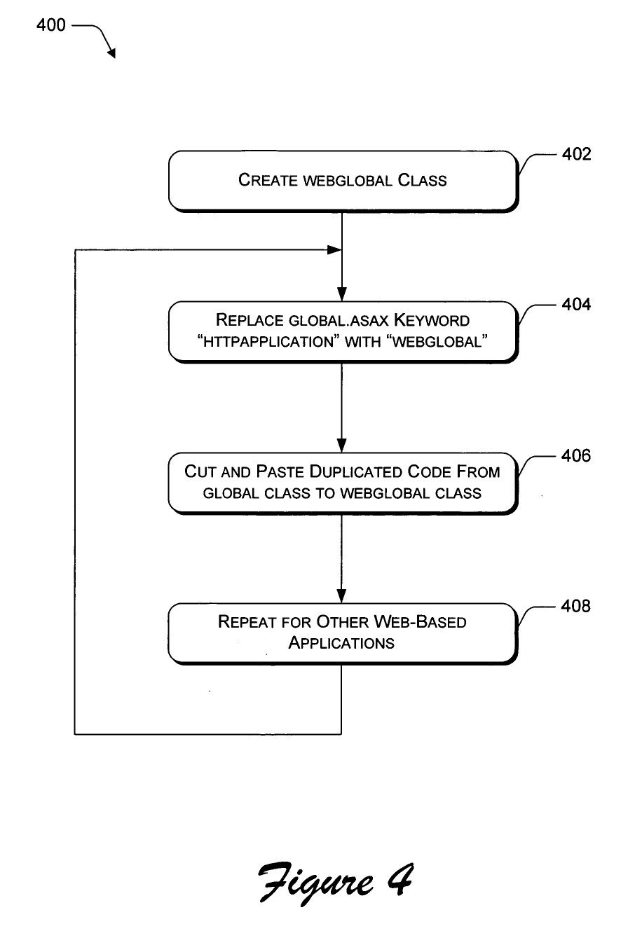

FIG. 4 is a flow diagram that illustrates an exemplary method 400 for modifying a web-based application to utilize the web application framework. The illustrated process can be implemented in any suitable hardware, software, firmware or combination thereof.

At block 402, a developer creates a class associated with the web application framework (e.g., a webglobal class). The webglobal class is defined to inherit from the System.Web.HttpApplication class associated with the ASP.NET framework.

At block 404, the developer replaces the keyword “System.Web.HttpApplication” with the keyword “webglobal” in the application-specific Global.asax file. This will cause the ASP.NET runtime to look first to the webglobal class before looking to the System.Web.HttpApplication class for global code.

At block 406, code that is duplicated across multiple applications or code that the developer desires to make available to multiple applications is pulled out of the application-specific global class and added to the web application framework webglobal class.

Block 408 indicates that the modifications performed with respect to blocks 404 and 406 are repeated for each additional web-based application that is to be configured to utilize the web application framework.

Conclusion

The techniques described above provide a framework in which centralized code can be maintained and accessed by multiple web-based applications. Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
maintaining a custom code module that can be automatically accessed by multiple web-based applications, such that the code module is not specifically associated with any particular web-based application; and
modifying a particular web-based application to automatically access the custom code module.

2. The method as recited in claim 1 wherein the particular web-based application is implemented using ASP.NET.

3. The method as recited in claim 1 wherein the maintaining comprises:
generating a webglobal class that inherits from an ASP.NET System.Web.HttpApplication class; and
generating the custom code module as part of the webglobal class.

4. The method as recited in claim 3 wherein the modifying comprises modifying a global class associated with the particular web-based application that inherits from the ASP.NET System.Web.HttpApplication class to inherit from the webglobal class.

5. The method as recited in claim 4 wherein the modifying further comprises adding code to the global class associated with the particular web-based application to customize a code module associated with the webglobal class.

6. The method as recited in claim 3 wherein the custom code module is designed to override a code module associated with the System.Web.HttpApplication class.

7. The method as recited in claim 3 wherein the custom code module is designed to customize a code module associated with the System.Web.HttpApplication class.

8. The method as recited in claim 1 wherein the modifying comprises altering a class associated with the particular web-based application to inherit from a class comprising the custom code module.

9. One or more computer-readable media having computer-readable instructions thereon which, when executed by a computer, cause the computer to implement the method as recited in claim 1.

10. A web server comprising:
a runtime framework comprising an System.Web.HttpApplication class of objects or methods;
a web application framework comprising a webglobal class of objects or methods configured to inherit from the System.Web.HttpApplication class; and
a web-based application comprising a global class of objects or methods configured to inherit from the webglobal class.

11. The web server as recited in claim 10 wherein the runtime framework comprises an ASP.NET framework.

12. The web server as recited in claim 10 wherein the web-based application comprises an ASP.NET application.

13. A system comprising:
means for executing a first web-based application;
means for executing a second web-based application; and
means for maintaining custom code that can be automatically accessed by the first web-based application and the second web-based application.

14. One or more computer-readable media comprising computer-readable instructions which, when executed, cause a computer system to:
maintain a first web-based application;
maintain a second web-based application; and
maintain custom code that can be automatically executed via the first web-based application and via the second web-based application.
